(19) United States
(12) Patent Application Publication
(10) Pub. No.: US 2003/0151018 A1
(43) Pub. Date: Aug. 14, 2003

(54) Solenoid valve

(76) Inventors: Nobutaka Teshima, Obu-shi (JP); Kiyoshi Yoshizumi, Toyota-shi (JP)

Correspondence Address: STEVENS, DAVIS, MILLER & MOSHER, L.L.P., Suite 850, 1615 L Street, N.W., Washington, DC, 20036, US

(21) Appl. No.: 10/359,610

(22) Filed: Feb. 7, 2003

(30) Foreign Application Priority Data
Feb. 13, 2002 (JP) 2002-034835
Feb. 13, 2002 (JP) 2002-034836

(51) Int. Cl. F16K 31/02

(52) U.S. Cl. 251/332; 251/129.15

(57) ABSTRACT

In a solenoid valve, for preventing an elastic sheet used in a valve portion from being damaged by high-pressure gas flow, and without a seal in a wiring portion connected to a coil preventing pressure leakage from the wiring portion difficult to be sealed, particularly in a solenoid valve used for distribution control of high-pressure gas, a valve body is made of an inelastic material and dome-shaped, and a sheet surface facing the valve body is divided in a radial direction into an inelastic sheet surface closer to an axis of the valve body in a radial direction, and an elastic sheet surface far from the axis. The former is inclined to the valve body at a predetermined angle θ1 to a line orthogonal to the axis of the valve body. The latter is inclined at an angle θ2 larger than the angle θ1 of the inelastic sheet surface. An elastic sheet surface in a boundary portion between the former and the latter is set on the same position as or lower than the inelastic sheet surface.

### BACKGROUND OF THE INVENTION

1. Field of the Invention

The present invention relates to a solenoid valve, for example to a solenoid valve installed in a fuel system for supplying high-pressure gas such as natural gas from a high-pressure tank mounted on a vehicle to an engine, or a solenoid valve mounted in a tank storing compressed gas, and used to take out the compressed gas from the tank by its opening operation.

2. Description of the Related Art

Conventionally, as a valve portion structure of a solenoid valve, for example as shown in an example 1 of FIG. 15, there has generally been known a structure where a valve body 1103 is installed oppositely to a sheet member 1102 having an outlet path 1101, the valve body 1103 is provided with an elastic seal plate 1104 made of rubber or the like, during valve closing as shown in FIG. 16, and the valve body 1103 is moved close to the sheet member 1102 to press the elastic seal plate 1104 into contact with the sheet member 1102, thereby cutting off a gas flow from a high-pressure side A to a low-pressure side B. Additionally, as shown in FIG. 15, a surface 1105 of the elastic seal plate 1104 is disposed to project from a surface 1106 of the valve body 1103.

As the aforementioned conventional example 1, in the valve portion structure where the surface 1105 of the elastic seal plate 1104 projects from the surface 1106 of the valve body 1103, when the valve body 1103 is slightly opened from a closed state of FIG. 16 to form a gap D1 as shown in FIG. 17, high-pressure gas on the high-pressure side A flows through the gap D1 to the low-pressure side B as indicated by an arrow, and this high pressure presses the elastic seal plate 1104 to the low-pressure side B to be deformed as shown in FIG. 17. The occurrence of such deformation generates cracks in a deformed portion 1104a, consequently creating a problem that durability of the solenoid valve is reduced.

Also conventionally, for example, as an example 2, there has been known a method for mounting a pressure tank (referred to as a tank, hereinafter) filled with compressed natural gas used as automobile fuel, hydrogen gas of an automobile fuel cell or the like on an automobile, and taking out the necessary amount of the compressed natural gas or the like from the tank by opening/closing a solenoid valve. This solenoid valve is mounted in the tank to project. As a harness wiring method for connecting an exciting coil of this solenoid valve with a connector installed outside the tank, a method is disclosed in JP-A-7-301359, U.S. Pat. No. 5,341,844 or the like, which draws the harness out of the solenoid valve into the tank, and then out of the tank through a member for holding the solenoid valve.

As the conventional example 2, in the structure where the harness is first drawn out of the solenoid valve into the tank, and then drawn out of the tank, a structure must be employed in which a seal member is disposed in a gap between the harness and the member to prevent pressure leakage. However, it is difficult to obtain the sealing effect on the harness portion having elasticity. Thus, there may be pressure leakage particularly in the tank filled with high-pressure gas or the like.

### SUMMARY OF THE INVENTION

With respect to the problem in the conventional example 1, a primary object of the present invention is to provide a solenoid valve for high-pressure wherein generation of cracks in an elastic seal member, as mentioned above, is prevented.

Further, with respect to the problem in the conventional example 2, a secondary object of the present invention is to provide a solenoid valve mounted in a tank wherein, without applying the above mentioned seal member to a wiring portion, even in a high-pressure tank, pressure leakage is surely prevented in the wiring portion.

In order to achieve the primary object, according to a first aspect of the present invention, there is provided a solenoid valve comprising a valve body made of an inelastic material, and a sheet surface placed oppositely to the valve body and divided in a radial direction to be constituted of an inelastic sheet surface disposed at a side closer to an axis of the valve body in a radial direction and an elastic sheet surface disposed at a side far from the axis of the valve body in the radial direction, wherein the elastic sheet surface in a boundary portion between the elastic sheet surface and the inelastic sheet surface is set on the same position as that of the inelastic sheet surface or lower than (i.e., concave from) the inelastic sheet surface.

According to a second aspect of the present invention, there is provided a solenoid valve comprising a valve body made of an inelastic material and dome-shaped, and a sheet surface placed oppositely to the valve body and divided in a radial direction to be constituted of an inelastic sheet surface disposed on a side closer to an axis of the valve body in a radial direction, and an elastic sheet surface disposed on a side far from the axis of the valve body in the radial direction, wherein the inelastic sheet surface is inclined to the valve body by a predetermined angle with respect to a line orthogonal to the axis of the valve body, the elastic sheet surface is inclined by an angle larger than the angle of the inelastic sheet surface with respect to the line orthogonal to the axis of the valve body, and the elastic sheet surface in a boundary portion between the elastic sheet surface and the inelastic sheet surface is set on the same position as or lower than the inelastic sheet surface.

In the solenoid valve according to the second aspect, the inelastic and elastic sheet surfaces may be both linear and tapered to form a two-stage tapered surface in which the inelastic and elastic sheet surfaces are continuously connected with each other.

In the solenoid valve according to the second aspect, further, the inelastic sheet surface may be linear and tapered, and the elastic sheet surface may be curved.

In the foregoing, when the valve is closed, the inelastic valve body is first pressed into contact with the elastic sheet surface to compress the elastic sheet, and then the inelastic valve body is pressed into contact with the inelastic sheet surface to prevent high-pressure gas on a high-pressure side from being leaked to a low-pressure side.

Then, in the case that the valve is opened from the closed state, when a small gap is generated between the valve body and the inelastic sheet surface, the high-pressure gas on the high-pressure side presses the elastic sheet surface to flow out to the low-pressure side. In this case, since in the boundary portion the elastic sheet surface and the inelastic sheet surface are set on the same position, or the elastic sheet surface is set lower than the inelastic sheet surface, the flowing high-pressure gas causes no deformation in the elastic sheet of the boundary portion, whereby cracks/damages of the elastic sheet are prevented.

In the foregoing, when the valve body has a dome-shaped constitution, the valve body may be made of an inelastic material and formed to be semispherical.

In the foregoing, further, when the valve body has a dome-shaped valve body, a press-contact surface of the valve body with the elastic sheet surface may be formed to be circular-arc.

In the foregoing, moreover, when the valve body has a dome-shaped constitution, a press-contact surface of the valve body with the elastic sheet surface may be formed to be linear, and a portion between the press-contact surface and the other surface adjacent to the press-contact surface may be formed to be circular-arc.

In the foregoing, because of no corner parts present in the press-contact surface of the valve body for pressing the elastic sheet surface, there is no danger of damages such as cracks on the elastic sheet surface by the valve body.

Further, in order to achieve the secondary object, according to a third aspect of the present invention, there is provided a solenoid valve for taking out pressure from the tank to the outside of the tank, at least a coil portion of the solenoid valve being attached to be positioned in the tank, and a wiring for supplying power to the coil portion being drawn through the inside of a solenoid valve casing to the outside of the tank without being drawn into the tank.

In order to achieve the secondary object, further, according to a fourth aspect of the present invention, there is provided a solenoid valve for taking out pressure from a tank to the outside of the tank, comprising a solenoid valve casing disposed to pass through the tank from the outside to the inside so as to position a coil portion in the tank, and a wiring portion from the coil portion to the outside of the tank disposed in the casing, wherein a wiring connected to the coil is drawn through the wiring portion to the outside of the tank, and sealing is executed to prevent leakage of pressure in the tank through a gap between members of the solenoid valve to the wiring portion.

### BRIEF DESCRIPTION OF THE DRAWINGS

FIG. 1 is a sectional view showing a solenoid valve according to a first embodiment of the present invention.

FIG. 2 is an enlarged sectional view of a valve portion of FIG. 1, showing a valve opened state.

FIG. 3 is a sectional view showing a valve closed state set by moving a valve body from the valve opened state of FIG. 2.

FIG. 4 is a sectional view showing a state where the valve body is slightly opened from the valve opened state of FIG. 2.

FIG. 5 is an enlarged sectional view showing a valve portion of a solenoid valve according to a second embodiment of the present invention.

FIG. 6 is an enlarged sectional view of a valve portion of a solenoid valve according to a third embodiment of the present invention, showing a valve opened state.

FIG. 7 is an enlarged sectional view showing a valve closed state in the embodiment of FIG. 6.

FIG. 8 is an enlarged sectional view of a valve portion of a solenoid valve according to a fourth embodiment of the present invention, showing a valve opened state.

FIG. 9 is an enlarged sectional view showing a valve closed state in the embodiment of FIG. 8.

FIG. 10 is an enlarged sectional view showing a valve portion of a solenoid valve according to a fifth embodiment of the present invention.

FIG. 11 is a vertical sectional view showing a main portion of a solenoid valve according to a sixth embodiment of the present invention.

FIG. 12 is a schematic side sectional view showing a mounted state of the solenoid valve of FIG. 11 to a tank.

FIG. 13 is a vertical sectional view showing a main portion of a solenoid valve according to a seventh embodiment of the present invention.

FIG. 14 is a vertical sectional view showing a main portion of a solenoid valve according to an eighth embodiment of the present invention.

FIG. 15 is a view of a conventional valve portion, showing a valve opened state.

FIG. 16 is a sectional view showing a valve closed state set by moving a valve body from the valve opened state of FIG. 15.

FIG. 17 is a sectional view showing a state where the valve body is slightly opened from the valve closed state of FIG. 16.

### DESCRIPTION OF THE PREFERRED EMBODIMENTS

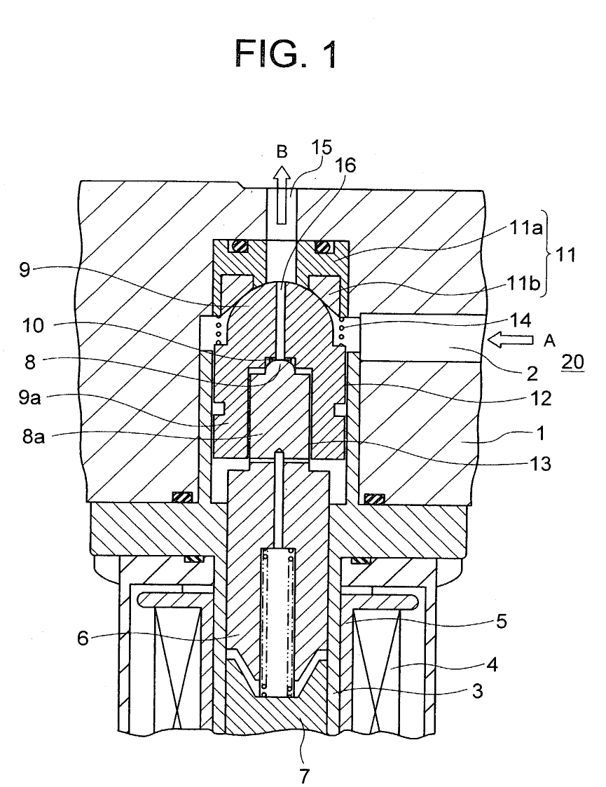

The preferred embodiments according to the present invention will be described with reference to FIGS. 1 to 14.

FIGS. 1 to 4 show a first embodiment.

FIG. 1 shows an embodiment where the present invention is applied to a pilot solenoid valve for a high-pressure tank having inner pressure of, e.g., 35 to 70 MPa. A housing 1 constituting the solenoid valve is secured to a not-shown tank, an inlet 2 formed in the housing 1 is opened in a high-pressure chamber 20 in the tank, and high-pressure gas in the tank is introduced from a high-pressure side A.

A cylindrical guide 3 is fixed in the housing 1, and a bobbin 5 having an exciting coil 4 wound thereon is disposed on the outer periphery of the guide 3. In the guide 3, a plunger 6 is slidably disposed, and a stator 7 is fixed. When the exciting coil 4 is energized, the plunger 6 is sucked to move to the stator 7.

A pilot valve 8a is disposed on an corresponding side of the plunger 6 to the stator 7, and a main valve 9a is slidably disposed on the outer periphery of the pilot valve 8a. A dome-shaped valve body 8 is formed at a top of the pilot valve 8a, and a pilot sheet 10 is disposed on a corresponding side of the main valve 9a to the valve body 8. The valve body 8 is formed to be semispherical in the shown example.

A dome-shaped valve body 9 is formed on a top of the main valve 9a, and a main sheet 11 constituted of an inelastic sheet 11a and an elastic sheet 11b is disposed on a corresponding side of the housing 1 to the valve body 9. The valve body 9 is formed to be semispherical in the shown example.

In a state of FIG. 1, when the exciting coil 4 is energized, the plunger 6 is sucked to move toward the stator 7, the valve body 8 of the pilot valve 8a is moved apart from the pilot sheet 10, and high-pressure gas in the tank is passed from the inlet 2 through a gap 12 between the main valve 9a and the guide 3 and a gap 13 between the pilot valve 8a and the main valve 9a and through the pilot sheet 10 to a distribution hole 16 and an outlet 15, thereby reducing differential pressure between the distribution hole 16 and the outlet 15 side and the inlet 2 side. Accordingly, the valve body 9 of the main valve 9a is moved apart from main sheet 11 by a pressing force of a spring 14, and the high-pressure gas in the tank is passed from the inlet 2 through a gap between the valve body 9 of the main valve 9a and the main sheet 11 to be taken out from the outlet 15 which is a low-pressure side B. In FIG. 1, a reference numeral 16 denotes a distribution hole.

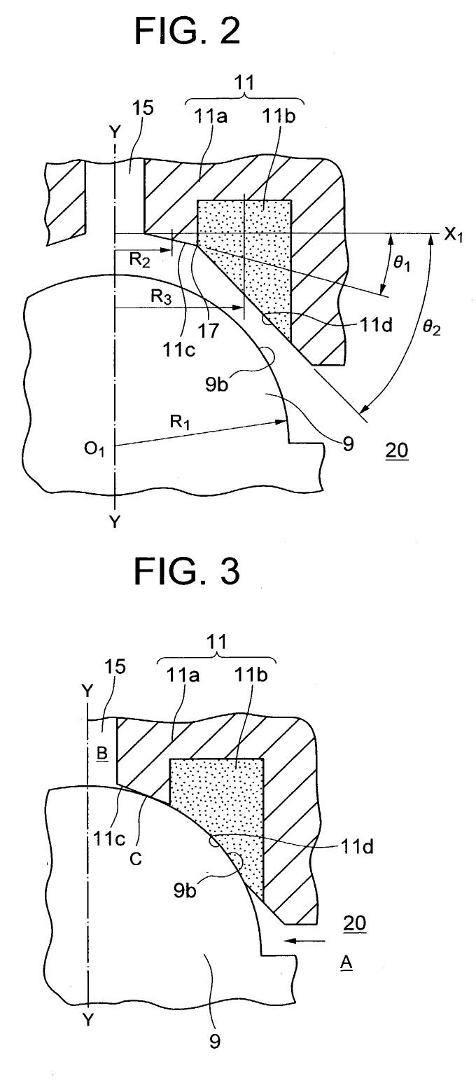

The present invention can be applied to the valve body 8 of the pilot valve 8a and the pilot sheet 10, and the valve body 9 of the main valve 9a and the main sheet 11. The present invention will now be described by taking an example of the valve body 9 of the main valve 9a and the main sheet 11 with reference to FIGS. 2 to 4.

In FIG. 2, the valve body 9 is formed in a semispherical shape of a radius R1 having a center O1 on an axis Y-Y, made of an inelastic material such as metal, and moved back and forth along the axis Y-Y, i.e., up and down in FIG. 2.

On the side corresponding to the valve body 9, the sheet 11 is disposed concentrically to the valve body 9, and the outlet 15 is formed in the axis Y-Y portion of the sheet 11.

The sheet 11 is constituted of the inelastic sheet 11a annular around the axis Y-Y and made of metal or the like, and the elastic sheet 11b annular around the axis Y-Y and made of rubber or the like, and is formed so that a sheet surface 11c of the inelastic sheet 11a is closer to the axis Y-Y than a sheet surface 11d of the elastic sheet 11b. In other words, the inelastic sheet surface 11c is arranged in a portion of a small diameter R2 around the axis Y-Y, and the elastic sheet surface 11d is arranged in a portion of a large diameter R3. Further, a radius R3 of the elastic sheet 11b to a center is set smaller than the radius R1 of the valve body 9.

Further, as shown in FIG. 2, the inelastic sheet surface 11c is formed to be a linear and tapered surface, which inclines to the valve body 9 at a predetermined angle θ1 to a line X1 orthogonal to the axis Y-Y. The elastic sheet surface 11d is formed to be a linear and tapered surface, which inclines to the valve body 9 at a predetermined angle θ2 larger than the angle θ1. Accordingly, the sheet surface is formed in a two-stage tapered shape. Additionally, a relation between a curvature of the valve body 9 and the tapered angles θ1 and θ2 is set so that when the semispherical valve body 9 approaches the sheet surface, the valve body 9 first abuts on the elastic sheet surface 11d, and then compresses the elastic sheet surface 11d to abut on the inelastic sheet surface 11c.

Further, a boundary portion 17 of the inelastic sheet surface 11c and the elastic sheet surface 11d is formed on the same position without any steps therebetween. In the boundary portion 17, the elastic sheet surface 11d may be slightly deeper (lower) than (i.e., concave from) the inelastic sheet surface 11c, in other words, a height of the elastic sheet surface 11d may be set lower than (i.e., concave from) that of the inelastic sheet surface 11c.

In the aforementioned structure, when the valve body 9 is moved from the valve opened state of FIG. 2 in a valve closing direction (upward in the drawing), the surface 9b of the valve body 9 is first brought into contact with the elastic sheet surface 11d. When the valve body 9 is further moved in the closing direction (upward in the drawing) from this state, as shown in FIG. 3, the valve body 9 is pressed to the elastic sheet surface 11d to compress the elastic sheet 11b, and the valve body 9 is pressed into contact with the inelastic sheet surface 11c of the inelastic sheet 11a. In this press-contact state, in a radial direction shown in FIG. 3, the surface 9b of the valve body 9 and the elastic sheet surface 11d are in surface-contact with each other while the surface 9b of the valve body 9 and the inelastic sheet surface 11c are in point-contact with each other. Additionally, in a circumferential direction, the surface 9b of the valve body 9 and the inelastic sheet surface 11c are in line-contact with each other.

Thus, the press-contact between the surface 9b of the valve body 9 and the inelastic sheet surface 11c enables prevention of leakage of high-pressure gas on the high-pressure side A to the low-pressure side B of FIG. 3.

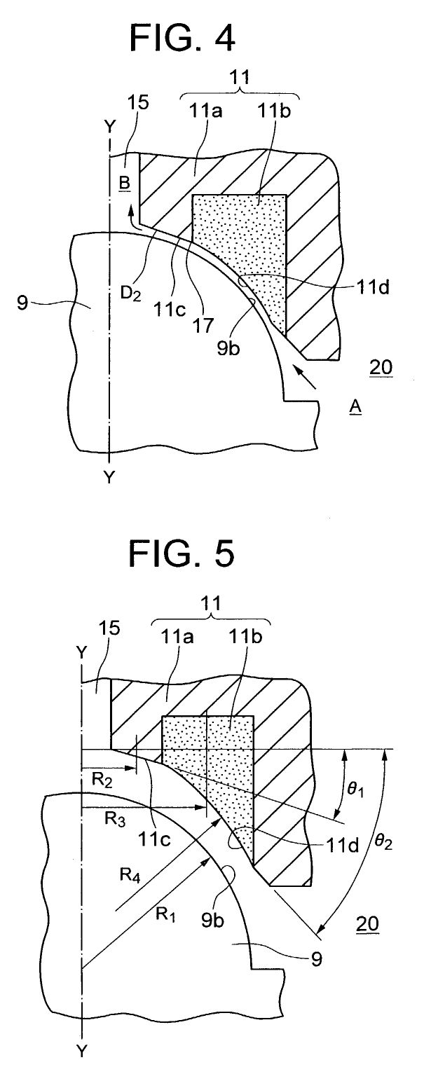

Subsequently, when the valve is opened from the closed state, as shown in FIG. 4, the valve body 9 is moved slightly apart from the inelastic sheet surface 11c, i.e., at the instance of valve opening, the high-pressure gas on the high-pressure side A presses the elastic sheet surface 11d to flow out through a gap D2 between the valve body 9 and the inelastic sheet surface 11c to the outlet 15 on the low-pressure side B.

At this time, the flow of the high-pressure gas applies a pressing force in a low-pressure side direction to the elastic sheet surface 11d. However, since there are no projected portions in the elastic sheet surfaces 11d and, in the boundary portion 17 of the elastic sheet surface 11d and the inelastic sheet surface 11c, the elastic sheet surface 11d does not project from the inelastic sheet surface 11c, no deformation occurs in the elastic sheet 11b in the flowing direction of the high-pressure gas. Thus, no cracks/damages which have occurred in the conventional art are generated in the elastic sheet 11b. Moreover, since the valve body 9 is formed to be semispherical, there is no danger of damages such as cracks generated in the elastic sheet surface 11d by the valve body 9.

FIG. 5 shows a second embodiment according to the invention.

According to the second embodiment, the elastic sheet surface 11d of the first embodiment is formed to be, in a radial direction, a curved surface of a curvature different from that of the valve body 9. That is, the elastic sheet surface 11d is formed to be a circular-arc curved surface having a radius R4 larger than the radius R1 of the valve body 9.

Other structures are similar to those of the first embodiment. Thus, portions similar to those of the first embodiment are denoted by similar reference numerals, and description thereof will be omitted.

The second embodiment exhibits operations and effects similar to those of the first embodiment.

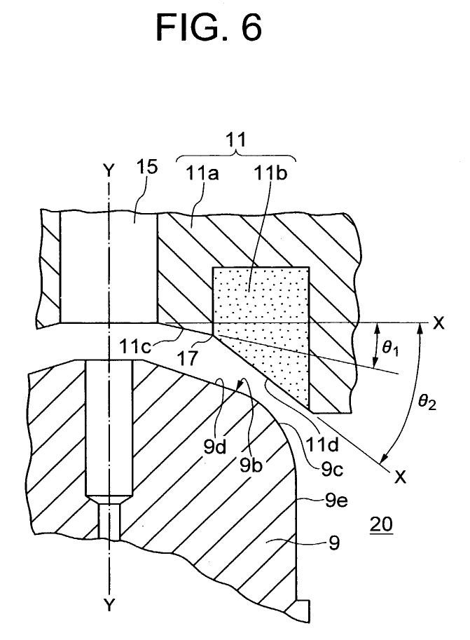

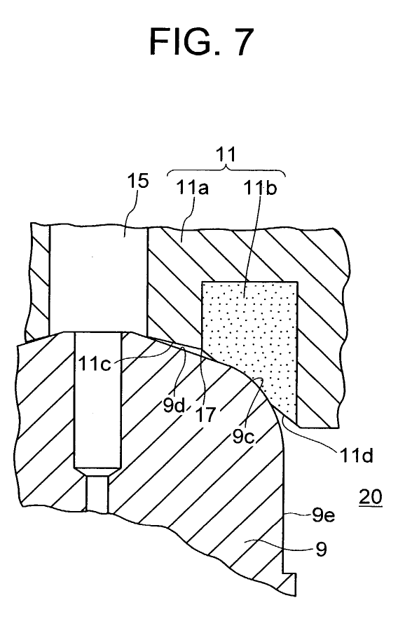

FIGS. 6 and 7 show a third embodiment according to the invention.

The third embodiment is a modified example of the valve body 9 of the first embodiment.

That is, a press-contact surface 9c in the surface 9b of the valve body 9 to the elastic sheet surface 11d is formed to be a circular arc surface having a center in the valve body 9, and an inner surface 9d closer to the axis Y-Y with respect to the press-contact surface 9c and an outer surface 9e far from the axis Y-Y with respect to the press-contact surface 9c are formed to be linear.

Other structures are similar to those of the first embodiment. Thus, portions similar to those of the first embodiment are denoted by similar reference numerals, and description thereof will be omitted.

According to the third embodiment, when the valve body 9 is raised from the valve opened state of FIG. 6, as shown in FIG. 7, the press-contact surface 9c of the valve body 9 compresses the elastic sheet surface 11d, and the inner surface 9d of the valve body 9 is pressed into contact with the inelastic sheet surface 11c.

The third embodiment also exhibits operations and effects similar to those of the first embodiment.

Incidentally, the valve body of the third embodiment may be applied to the second embodiment.

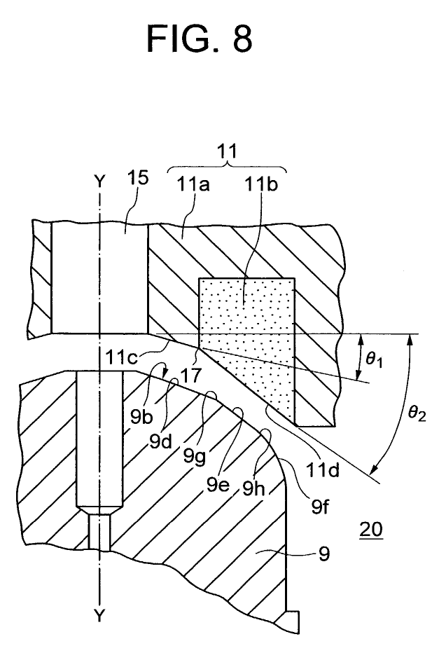

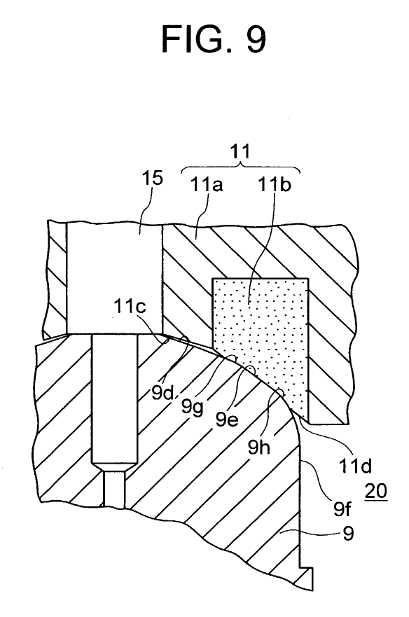

FIGS. 8 and 9 show a fourth embodiment according to the invention.

The fourth embodiment is a modified example of the valve body 9 of the first embodiment.

That is, a press-contact surface 9e in the surface 9b of the valve body 9 to the elastic sheet surface 11d is formed to be linear (planar), other adjacent surfaces 9d, 9f are formed to be linear (planar), and circular arc surfaces 9g, 9h are formed between the press-contact surface 9e and the other surface 9d, 9f.

Other structures are similar to those of the first embodiment. Thus, portions similar to those of the first embodiment are denoted by similar reference numerals, and description thereof will be omitted.

The fourth embodiment also exhibits operations and effects similar to those of the first embodiment.

Incidentally, the valve body of the fourth embodiment may be applied to the second embodiment.

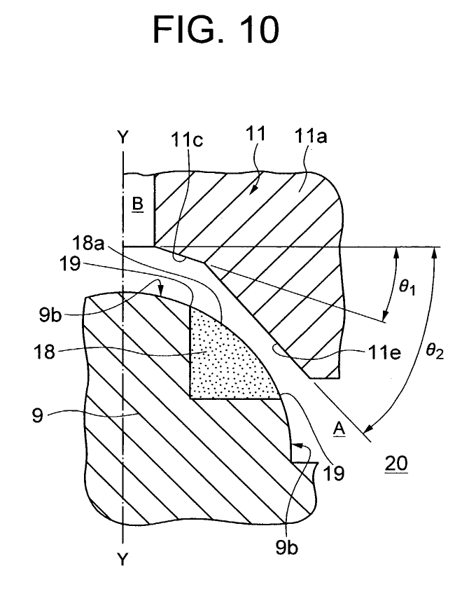

FIG. 10 shows a fifth embodiment according to the invention.

According to the fifth embodiment, the elastic sheet 11b of the first embodiment is also constituted of an inelastic sheet 11a, the sheet surface 11d of the first embodiment is made to be an inelastic sheet surface 11e integral with a sheet surface 11c, and a portion of the semispherical valve body 9 brought into contact with the sheet surface 11e is provided with an elastic valve portion 18 made of an elastic material such as rubber. The elastic valve portion 18 is formed to be annular around the axis Y-Y. Additionally, a surface 18a of the elastic valve body 18 is formed to be a part of a spherical surface of the same radius as that of the surface 9b of the valve body 9, i.e., on an extension of the spherical surface of the valve body 9. Further, a boundary portion 19 between the surface 18a of the elastic valve portion 18 and the inelastic surface 9b of the valve body 9 is formed so that both surfaces are formed on the same position or the surface 18a of the elastic valve portion 18 is slightly lower.

Other structures are similar to those of the first embodiment. Thus, portions similar to those of the first embodiment are denoted by similar reference numerals, and description thereof will be omitted.

According to the fifth embodiment, when the valve is closed, the elastic valve portion 18 of the valve body 9 is first brought into contact with the inelastic sheet surface 11e to be compressed, and then the surface 9b of the inelastic material is brought into contact with the inelastic sheet surface 11c.

Then, in valve opening, when the valve is slightly opened, high-pressure gas is passed from the high-pressure side A to the low-pressure side B. At this time, however, since the surface 18a of the elastic valve portion 18 does not project from the surface 9b of the valve body 9 in the boundary portion 19 of the elastic valve portion 18 and the inelastic valve portion 19, the flow of the high-pressure gas causes no deformation in the elastic valve portion 18. Thus, no cracks/damages similar to those of the conventional art are generated in the elastic valve body 18.

The embodiments have been described by way of example where the present invention is applied to the pilot solenoid valve. However, the present invention is not limited to the pilot solenoid valve, and it can be applied to other solenoid valves for controlling distribution of high-pressure gas or the like.

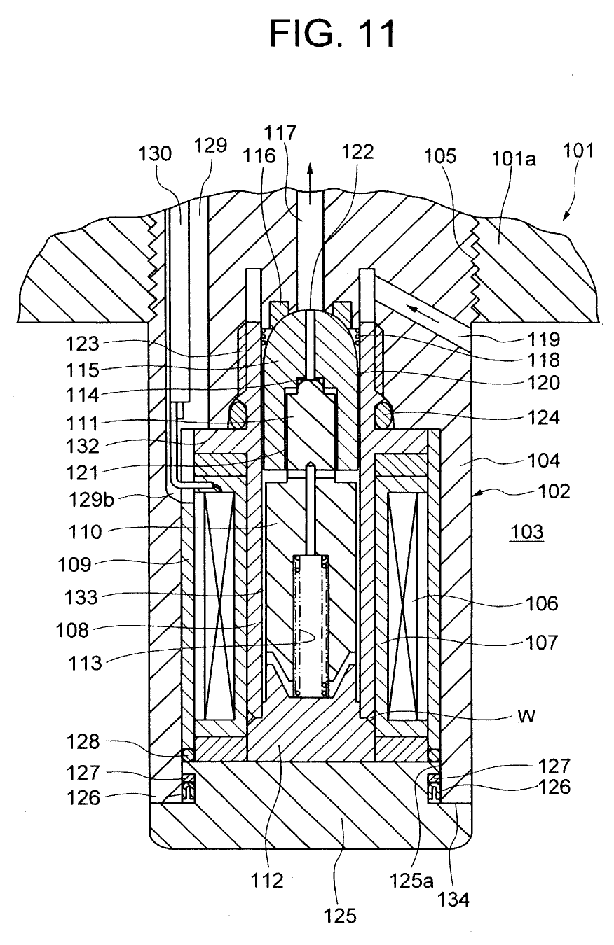

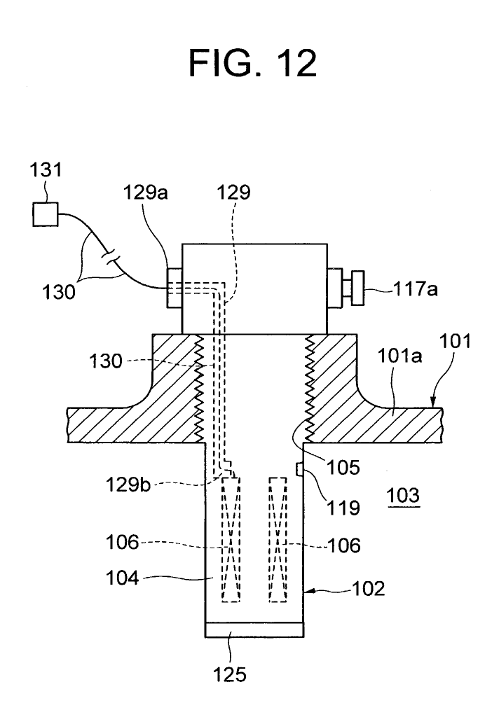

FIGS. 11 and 12 show a sixth embodiment according to the invention.

FIG. 11 is a main portion sectional view showing a state where a solenoid valve 102 is mounted in a fluid take-out portion of a tank 101, and FIG. 12 is a schematic side view of the state mounted the solenoid valve of FIG. 11 in the tank, where the solenoid valve 102 is inserted from the outside of the tank 101 into a tank chamber 103, i.e., a high-pressure side.

The solenoid valve 102 has a cylindrical casing 104, an upper part of the casing 104 is fixed to a constituent wall 101a of the tank 101 by a screw 105, a lower part of the casing 104 is inserted into the tank chamber 103, and an upper end part projects to the outside of the tank 101.

In a portion in the casing 104 and positioned in the tank, a bobbin 107 having an exciting coil 106 wound thereon is disposed, a cylindrical guide 108 is disposed in the inner periphery of the bobbin 107, and a holding cylinder 109 is fitted to the outer periphery of the bobbin 107. The holding cylinder 109 is fitted in the casing 104. A plunger 110 is disposed so as to axially slide in the guide 108. One end of the plunger 110 is provided with a pilot valve 111, and the other end faces a fixed stator 112 so as to be attachable and detachable. When the coil 106 is energized, the plunger 110 is sucked to the stator 112 side against a spring 113, and the pilot valve 111 is moved apart from the a pilot sheet 114 to be opened. Additionally, when the energizing of the coil 106 is cut off, a pressing force of the spring 113 presses the pilot valve 111 into contact with the pilot sheet 114 to be closed.

In the inner periphery of the guide 108 and the outer periphery of the pilot valve 111, a main valve 115 having the pilot sheet 114 is disposed so as to axially slide, an annular main sheet 116 is disposed on the casing 104 correspondingly to the main valve 115, and the main valve 115 is arranged to be attachable to/detachable from the main sheet 116. An outlet 117 is formed in a center of the main sheet 116. The main valve 115 is pressed into contact with the main sheet 116 to close the outlet 117. The main valve 115 is moved apart from the main sheet 116 by a spring 118 to open the outlet 117.

Then, when the coil 106 is energized, the plunger 110 is moved downward in FIG. 11, a fluid in the tank chamber 103 flows from an inlet 119 formed in the casing 104 through a gap 120 between the main valve 115 and the guide 108 and a gap 121 between the main valve 115 and the pilot valve 111 into the pilot sheet 114, and flows out from a hole 122 to the outlet 117. Further, when differential pressure between the inlet 119 side and the outlet 117 side is reduced, and a pressing force of the spring 118 moves the main valve 115 apart from the main sheet 116, the fluid in the tank chamber 103 flows out from the inlet 119 through a gap between the main valve 115 and the main sheet 116 to the outlet 117. An outer end of the outlet 117 is communicated with a take-out port 117a outside the tank shown in FIG. 12.

The stator 112 and an end of the guide 108 on the stator 112 side are connected to each other by welding to form a welded portion W, and sealed over an entire periphery.

Further, the side of the guide 108 opposite the stator 112 is fixed to the casing 104 by a screw 123, a first seal member 124 is disposed between the outer peripheral part of the guide 108 and the casing 104, and the entire periphery between the guide 108 and the casing 104 is sealed.

A cap 125 is fixed to one end of the casing 104 inserted into the tank chamber 103 by proper fixing means, and the end portion of the casing 104 is covered with the cap 125. In the cap 125, a small-diameter fitting portion 125a is integrally formed to fit to the inner peripheral surface of the casing 104, a second seal member 126 is disposed between the outer peripheral surface of the fitting portion 125a and the inner peripheral surface of the casing 104, and the entire periphery between the cap 125 and the casing 104 is sealed by the second seal member 126. A reference numeral 127 denotes a resin ring.

A third seal member 128 is disposed between facing surfaces of the holding cylinder 109 and the cap 125 to back the second seal member 126 up.

For each of the seal members 124, 126 and 128, a resin O ring, a C ring C-shaped in section, a seal ring filled with inactive gas and sealed in, or the like can be used. Additionally, in place of such an O ring or the like, welding may be used for sealing.

In the casing 104, a wiring insertion hole 129 which is a wiring portion with an external wire is embedded along an axial direction of the casing 104. An inner opening 129b which is one end of the wiring insertion hole is opened in the bobbin 107, the other end is opened on an atmosphere side of the casing 104 projecting to the outside (atmosphere side) of the tank 101, and the wiring insertion hole 129 is formed not to open in the tank chamber 103. In FIG. 12, a reference numeral 129a denotes a wiring lead-out portion.

A wiring (harness) 130 is connected to the coil 106. The wiring 130 is passed from the inner opening 129b of the wiring insertion hole 129 through the wiring insertion hole 129, and drawn from the wiring lead-out portion 129a opened on the atmosphere side of the wiring insertion hole 129 to the outside of the tank, and its tip is connected to a connector 131. The connector 131 is connected to the external electric wire. Incidentally, in the wiring insertion hole 129, no seal members for sealing the wiring 130 and the casing 104 from each other are disposed.

With the aforementioned structure, a high-pressure fluid in the tank chamber 103 entering the screw 123 through the inlet 119 is sealed by the first seal member 124, whereby leakage is prevented from a joined portion 132 between the casing 104 and the guide 108 to the wiring insertion hole 129 which is a connection portion with the external electric wire.

The high-pressure fluid which has entered the guide 108 from the inlet 119 is passed through a gap 120 between the main valve 115 and the guide 108 to enter a gap 133 between the plunger 110 and the guide 108. However, leakage to the outside of the guide 108 is blocked by the welded portion W between the guide 108 and the stator 112, whereby leakage to the wiring insertion hole 129 is prevented.

Additionally, the high-pressure fluid which has entered a joined portion 134 between the casing 104 and the cap 125 is sealed by the second seal member 126, whereby the high-pressure fluid is prevented from being leaked through respective joined portions between the holding cylinder 109 and the casing 104, between the holding cylinder 109 and the bobbin 107, and between the bobbin 107 and the guide 108 to the wiring insertion hole 129.

Thus, the capability of preventing the leakage of the high-pressure fluid in the tank chamber 103 into the wiring insertion hole 129 which is the wiring portion eliminates the necessity of disposing a seal member in the wiring insertion hole 129 to seal between the wiring 130 and the casing 104 from each other, making it possible to solve the conventional difficulty of sealing in the wiring portion. In other words, it is possible to relatively easily prevent pressure leakage by a seal made of a hard material between the members.

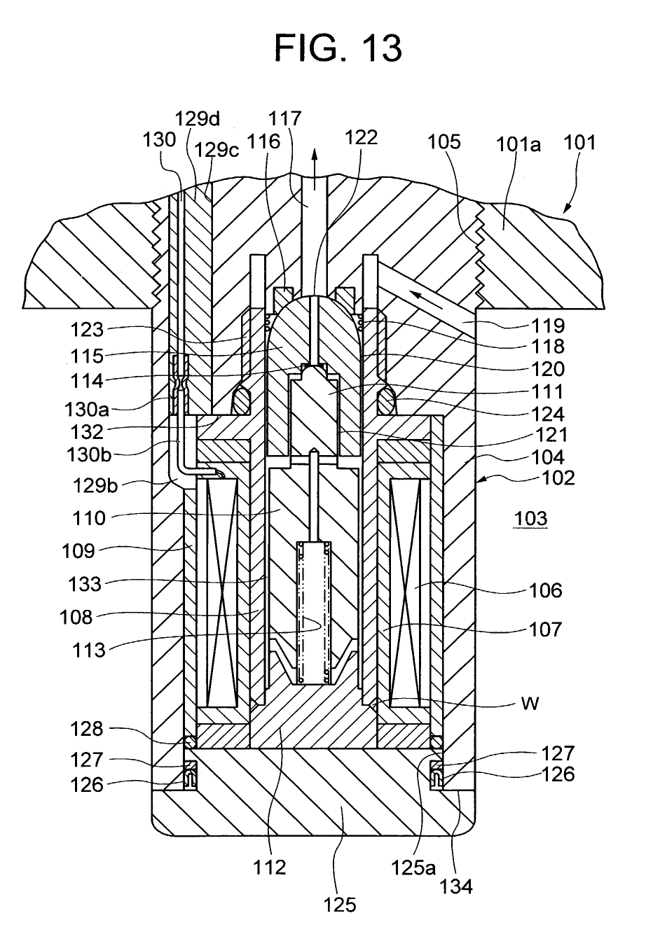

FIG. 13 shows a seventh embodiment according to the invention.

The seventh embodiment shows another example of the connection portion with the external electric wire of the sixth embodiment.

That is, in the casing 104 of the sixth embodiment, a hole 129c is formed so that one end thereof is opened in the bobbin 107, and the other end is opened on the atmosphere side of the casing 104 projecting to the outside (atmosphere side) of the tank 101. The wiring 130 provided with a female terminal 130a at an inner end is inserted into the hole 129c, and a resin layer 129d is formed by molding where the hole 129c excluding the wiring 130 and the female terminal 130a is filled with a resin material and solidified, to integrally form the wiring 130 and the female terminal 130a with the casing 104. Then, a male terminal 130b connected to the coil 106 is pressed into the female terminal 130a to be connected. The hole 129c and the resin layer 129d constitute a wiring portion with the external electric wire.

Other structures are similar to those of the sixth embodiment. Thus, portions similar to those of the sixth embodiment are denoted by similar reference numerals, and description thereof will be omitted.

The seventh embodiment exhibits operations and effects similar to those of the sixth embodiment. Additionally, airtightness is enhanced in the wiring portion 130 by the resin material 129b.

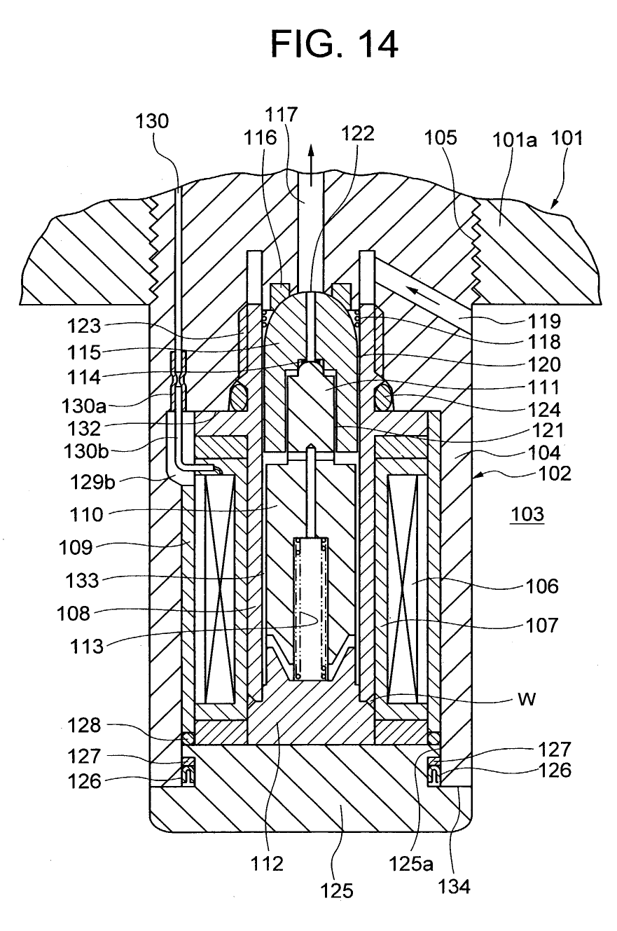

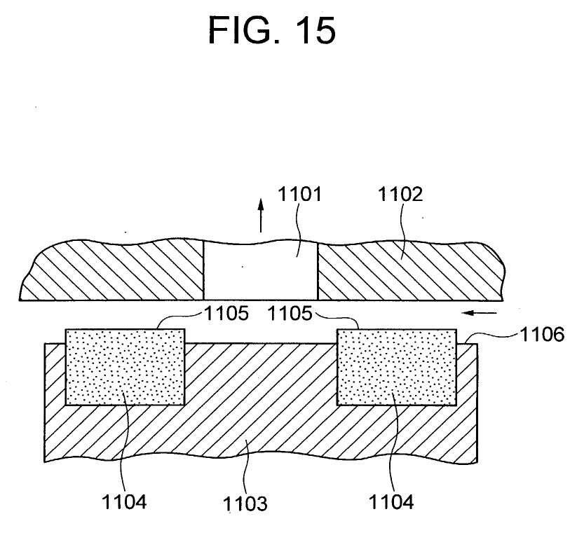

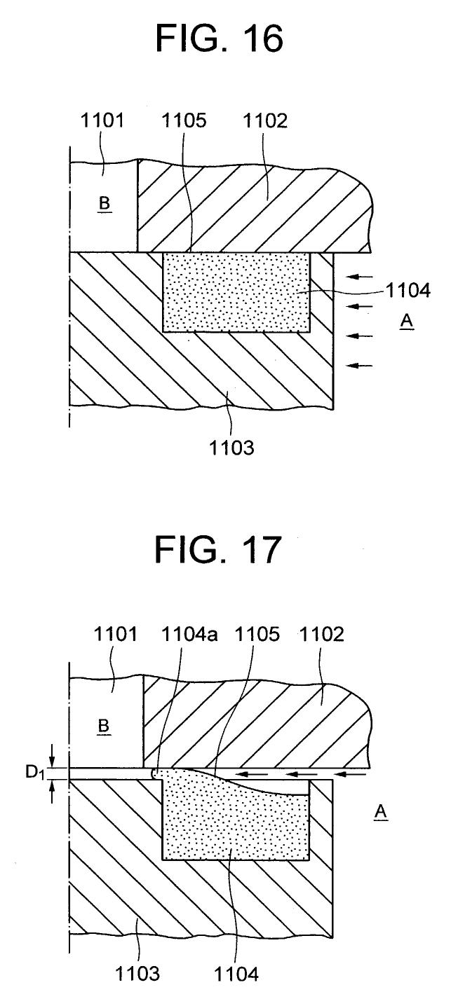

FIG. 14 shows an eighth embodiment according to the invention.

According to the eighth embodiment, in molding of a resin casing 104, the wiring 130 and the female terminal 130a shown in FIG. 13 are integrally formed with each other. In the embodiment, a portion into which the wiring 130 is inserted is a wiring portion with the external electric wire.

Other structures are similar to those of the sixth embodiment. Thus, portions similar to those of the sixth embodiment are denoted by similar reference numerals, and description thereof will be omitted.

The eight embodiment exhibits operations and effects similar to those of the seventh embodiment.

Incidentally, needless to say, the solenoid valve according to the present invention can be applied to a low-pressure tank, but it is particularly effective when the solenoid valve is applied to a high-pressure tank on which pressure of, e.g., 35 to 70 MPa, is applied, such as a fuel cell hydrogen tank loaded on an automobile.

As discussed above, according to the first and second aspects of the present invention, particularly in the solenoid valve used for distribution control of high-pressure gas, it is possible to prevent cracks/damages of the elastic member constituting the sheet surface or the like of the valve portion, thereby improving the durability of the solenoid valve.

Further, as discussed above, according to the third aspect of the present invention, since the wiring connected to the coil of the solenoid valve is drawn through the inside of the solenoid valve casing to the outside of the tank without being drawn from the solenoid valve into the tank, the sealing executed to prevent leakage of pressure in the tank through the gap between the components of the solenoid valve to the wiring portion can eliminate the necessity of seals in the wiring portion.

Therefore, particularly in the tank filled with the high-pressure fluid, it is possible to remove any seals in the wiring portion difficult to be sealed, and to prevent pressure in the tank from being leaked to the outside of the tank.

What is claimed is:

1. A solenoid valve comprising:
a valve body made of an inelastic material; and
a sheet surface facing the valve body and constituted of an inelastic sheet surface disposed closer to an axis of the valve body in a radial direction, and an elastic sheet surface disposed far from the axis of the valve body in the radial direction,
wherein an elastic sheet surface in a boundary portion between the elastic sheet surface and the inelastic sheet surface is set on the same position as or lower than the inelastic sheet surface.

2. A solenoid valve comprising:
a valve body made of an inelastic material and dome-shaped; and
a sheet surface facing the valve body and constituted of an inelastic sheet surface disposed closer to an axis of the valve body in a radial direction, and an elastic sheet surface disposed far from the axis of the valve body in the radial direction,
wherein the inelastic sheet surface is inclined toward the valve body at a predetermined angle to a line orthogonal to an axis of the valve body, the elastic sheet surface is inclined at an angle larger than the inclined angle of the inelastic sheet surface to the line orthogonal to the axis of the valve body, and an elastic sheet surface in a boundary portion between the elastic sheet surface and the inelastic sheet surface is set on the same position as or lower than the inelastic sheet surface.

3. The solenoid valve according to claim 2, wherein the inelastic and elastic sheet surfaces are both linear and tapered to form a two-stage tapered surface in which the inelastic and elastic sheet surfaces are continuously connected with each other.

4. The solenoid valve according to claim 2, wherein the inelastic sheet surface is linear and tapered, and the elastic sheet surface is curved.

5. The solenoid valve according to claim 2, wherein the valve body is made of an inelastic material and formed to be semispherical.

6. The solenoid valve according to claim 3, wherein the valve body is made of an inelastic material and formed to be semispherical.

7. The solenoid valve according to claim 4, wherein the valve body is made of an inelastic material and formed to be semispherical.

8. The solenoid valve according to claim 2, wherein a press-contact surface of the valve body with the elastic sheet surface is formed to be a circular-arc surface.

9. The solenoid valve according to claim 3, wherein a press-contact surface of the valve body with the elastic sheet surface is formed to be a circular-arc surface.

10. The solenoid valve according to claim 4, wherein a press-contact surface of the valve body with the elastic sheet surface is formed to be a circular-arc surface.

11. The solenoid valve according to claim 2, wherein the press-contact surface of the valve body with the elastic sheet surface is formed to be linear, and a portion between the press-contact surface and the other surface adjacent to the press-contact surface is formed to be a circular-arc surface.

12. The solenoid valve according to claim 3, wherein the press-contact surface of the valve body with the elastic sheet surface is formed to be linear, and a portion between the press-contact surface and the other surface adjacent to the press-contact surface is formed to be a circular-arc surface.

13. The solenoid valve according to claim 4, wherein the press-contact surface of the valve body with the elastic sheet surface is formed to be linear, and a portion between the press-contact surface and the other surface adjacent to the press-contact surface is formed to be a circular-arc surface.

14. A solenoid valve mounted in a tank to take out pressure from the tank to the outside of the tank, at least a coil portion of the solenoid valve being attached to be positioned in the tank, and a wiring for supplying power to the coil portion being drawn through an inside of a solenoid valve casing to the outside of the tank without being drawn into the tank.

15. A solenoid valve for taking out pressure from a tank to the outside of the tank, comprising:
a solenoid valve casing disposed to pass through from an outside of the tank to an inside and to position a coil portion in the tank; and
a wiring portion from the coil portion to the outside of the tank disposed in the casing,
wherein a wiring connected to the coil is drawn through the wiring portion to the outside of the tank, and sealing is executed to prevent leakage of pressure in the tank through a gap between members of the solenoid valve to the wiring portion.
